(19) United States
(12) Patent Application Publication
(10) Pub. No.: US 2021/0174144 A1
(43) Pub. Date: Jun. 10, 2021

(54) METHOD AND APPARATUS FOR OBTAINING TRAINING SAMPLE OF FIRST MODEL BASED ON SECOND MODEL

(71) Applicant: Advanced New Technologies Co., Ltd., Grand Cayman (KY)

(72) Inventors: Cen CHEN, Hangzhou (CN); Jun ZHOU, Hangzhou (CN); Chaochao CHEN, Hangzhou (CN); Xiaolong LI, Hangzhou (CN)

(21) Appl. No.: 17/173,062

(22) Filed: Feb. 10, 2021

Related U.S. Application Data
(63) Continuation of application No. PCT/CN2019/097428, filed on Jul. 24, 2019.

(30) Foreign Application Priority Data
Oct. 22, 2018 (CN) 201811230432.6

(51) Int. Cl. G06K 9/62; G06N 20/00; G06F 17/18

(52) U.S. Cl. CPC G06K 9/6256; G06F 17/18; G06N 20/00; G06K 9/6228

(57) ABSTRACT

Implementations of the present specification provide a method and an apparatus for obtaining a training sample of a first model based on a second model. The method includes obtaining at least one first sample, each first sample including feature data and a label value, the label value corresponding to a predicted value of the first model; and separately inputting feature data of the at least one first sample into the second model so that the second model separately outputs multiple first output values each based on feature data of a first sample of the at least one first sample, and obtaining a first training sample set from the at least one first sample based on the first output values separately output by the second model, a first output value being used to determine whether a corresponding first sample is selected as a training sample of the first training sample set, where the first training set is for training the first model.

### BACKGROUND

### Technical Field

Implementations of the present specification relate to machine learning, and more specifically, to a method and an apparatus for obtaining a training sample of a first model based on a second model.

### Description of the Related Art

In a payment platform such as ALIPAY, there are hundreds of millions of cash transactions every day, including a very small proportion of fraudulent transactions. Therefore, the fraudulent transactions need to be identified by using an anti-fraud model, for example, a trusted transaction model, an anti-money laundering model, or a card/account theft model. To train the anti-fraud model, usually, fraudulent transactions are used as positive examples and non-fraudulent transactions are used as negative examples. Usually, the number of positive examples is far less than the number of negative examples, for example, one thousandth, one ten thousandth, or one hundred thousandth of the number of negative examples. Therefore, it is difficult to train the model well when the anti-fraud model is directly trained by using a conventional machine learning training method. An existing solution is up-sampling positive examples or down-sampling negative examples.

Therefore, a more effective solution of obtaining a training sample of the model is needed.

### BRIEF SUMMARY

Implementations of the present specification provide a more effective solution of obtaining a training sample of a model, which, among others, alleviate the disadvantages of the existing technologies.

An aspect of the present specification provides a method for obtaining a training sample of a first model based on a second model, including obtaining at least one first sample, each first sample including feature data and a label value, the label value corresponding to a predicted value of the first model; and separately inputting feature data of the at least one first sample into the second model so that the second model separately outputs multiple first output values each based on feature data of a first sample of the at least one first sample, and obtaining a first training sample set from the at least one first sample based on the first output values separately output by the second model, a first output value being used to determine whether a corresponding first sample is selected as a training sample of the first training sample set, where the first training set is for training the first model.

In some implementations, the second model includes a probability function corresponding to feature data of an input sample, calculates a probability of selecting the input sample as a training sample of the first model based on the probability function, and outputs a corresponding output value based on the probability, the second model being trained by using training acts including obtaining at least one second sample, each second sample including feature data and a label value, the label value corresponding to a predicted value of the first model; separately inputting feature data of the at least one second sample into the second model so that the second model separately outputs multiple second output values each based on feature data of a second sample, and determining a second training sample set of the first model from the at least one second sample based on the second output values separately output by the second model, a second output value being used to determine whether a corresponding second sample is selected as a training sample of the second training sample set; training the first model by using the second training sample set, and obtaining a first predicted loss of a trained first model based on multiple determined test samples; calculating a reward value corresponding to the multiple second output values of the second model based on the first predicted loss; and training the second model by using a policy gradient algorithm based on the feature data of the at least one second sample, a probability function corresponding to each feature data in the second model, each second output value of the second model for each feature data of the at least one second sample, and the reward value.

In some implementations, the method further includes after the obtaining the first predicted loss of the trained first model based on the multiple determined test samples, restoring the first model to include model parameters that exist before the training.

In some implementations, the reward value is equal to a difference obtained by subtracting the first predicted loss from an initial predicted loss, and the method further includes after the obtaining the at least one second sample, randomly obtaining an initial training sample set from the at least one second sample; and training the first model by using the initial training sample set, and obtaining the initial predicted loss of a trained first model based on the multiple determined test samples.

In some implementations, the training acts are iterated for multiple times, and the reward value is equal to a difference obtained by subtracting a first predicted loss obtained in a current training from a first predicted loss obtained in a previous training immediately before the current training.

In some implementations, the at least one first sample is same as or different from the at least one second sample.

In some implementations, the first model is an anti-fraud model, the feature data is feature data of a transaction, and the label value indicates whether the transaction is a fraudulent transaction.

Another aspect of the present specification provides an apparatus for obtaining a training sample of a first model based on a second model, including a first sample acquisition unit, configured to obtain at least one first sample, each first sample including feature data and a label value, the label value corresponding to a predicted value of the first model; and an input unit, configured to separately input feature data of the at least one first sample into the second model so that the second model separately outputs multiple first output values each based on feature data of a first sample of the at least one first sample, and obtain a first training sample set from the at least one first sample based on the first output values separately output by the second model, a first output value being used to determine whether a corresponding first sample is selected as a training sample of the first training sample set, where the first training set is for training the first model.

In some implementations, the second model includes a probability function corresponding to feature data of an input sample, calculates a probability of selecting the sample as a training sample of the first model based on the probability function, and outputs a corresponding output value based on the probability, the second model being trained by a training apparatus, the training apparatus including a second sample acquisition unit, configured to obtain at least one second sample, each second sample including feature data and a label value, the label value corresponding to a predicted value of the first model; an input unit, configured to separately input feature data of the at least one second sample into the second model so that the second model separately outputs multiple second output values each based on feature data of a second sample, and determine a second training sample set of the first model from the at least one second sample based on the second output values separately output by the second model, a second output value being used to determine whether a corresponding second sample is selected as a training sample of the second training sample set; a first training unit, configured to train the first model by using the second training sample set, and obtain a first predicted loss of a trained first model based on multiple determined test samples; a calculation unit, configured to calculate a reward value corresponding to the multiple second output values of the second model based on the first predicted loss; and a second training unit, configured to train the second model by using a policy gradient algorithm based on the feature data of the at least one second sample, a probability function corresponding to each feature data in the second model, each second output value of the second model for each feature data of the at least one second sample, and the reward value.

In some implementations, the apparatus further includes a restoration unit, configured to after the first predicted loss of the trained first model based on the multiple determined test samples is obtained by using the first training unit, restore the first model to include model parameters that exist before the training.

In some implementations, the reward value is equal to a difference obtained by subtracting the first predicted loss from an initial predicted loss, and the apparatus further includes a random acquisition unit, configured to after the at least one second sample is obtained, randomly obtain an initial training sample set from the at least one second sample; and an initial training unit, configured to train the first model by using the initial training sample set, and obtain the initial predicted loss of a trained first model based on the multiple determined test samples.

In some implementations, implementation of the training apparatus is iterated for multiple times, and the reward value is equal to a difference obtained by subtracting a first predicted loss obtained in a currently implemented training apparatus from a first predicted loss obtained in a previously implemented training apparatus immediately before the currently implemented training apparatus.

Another aspect of the present specification provides a computing device, including a memory and a processor, the memory storing executable code, and the processor implementing any one of the above methods when executing the executable code.

The largest difference between the anti-fraud model and a conventional machine learning model is that a ratio of positive examples to negative examples is very small. To alleviate this problem, the most common solution is up-sampling positive samples or down-sampling negative samples. A ratio needs to be set manually for up-sampling positive examples or down-sampling negative examples, and an improper ratio greatly affects the model. The up-sampling positive examples or the down-sampling negative examples is manually changing data distribution, and therefore a trained model has a deviation. According to the solution of selecting a training sample of the anti-fraud model based on reinforcement learning according to the implementations of the present specification, a sample can be automatically selected through deep reinforcement learning, to train the anti-fraud model, thereby improving a predicted loss of the anti-fraud model.

### BRIEF DESCRIPTION OF THE SEVERAL VIEWS OF THE DRAWINGS

The implementations of the present specification can be made clearer by describing the implementations of the present specification with reference to the accompanying drawings:

FIG. 1 is a schematic diagram illustrating system 100 for obtaining a model training sample according to some implementations of the present specification;

FIG. 2 illustrates a method for obtaining a training sample of a first model based on a second model according to some implementations of the present specification;

FIG. 3 is a flowchart illustrating a method for training the second model according to some implementations of the present specification;

FIG. 4 illustrates apparatus 400 for obtaining a training sample of a first model based on a second model according to some implementations of the present specification; and

FIG. 5 illustrates training apparatus 500 configured to train the second model according to some implementations of the present specification.

### DETAILED DESCRIPTION

The following describes the implementations of the present specification with reference to the accompanying drawings.

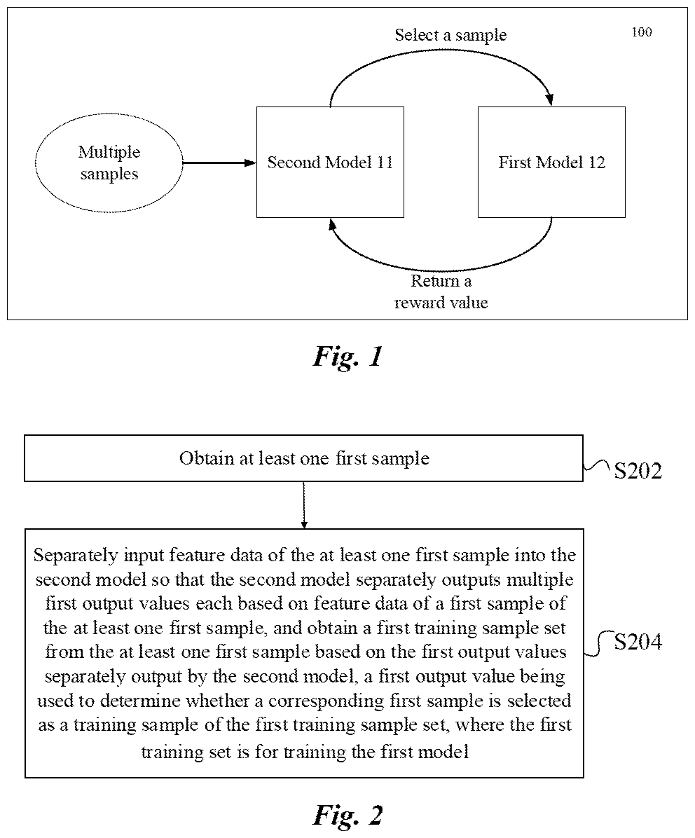

FIG. 1 is a schematic diagram illustrating system 100 for obtaining a model training sample according to some implementations of the present specification. As shown in FIG. 1, system 100 includes second model 11 and first model 12. Second model 11 is a deep reinforcement learning model, and second model 11 obtains a probability of selecting an input sample as a training sample of the first model based on feature data of the input sample, and outputs a corresponding output value based on the probability, the output value being used to predict whether to select the corresponding input sample as a training sample. First model 12 is a supervised learning model, for example, an anti-fraud model. The sample includes, for example, feature data of a transaction and a label value of the transaction, the label value indicating whether the transaction is a fraudulent transaction. After a batch of multiple samples is obtained, second model 11 and first model 12 can be trained alternately by using the batch of samples. Second model 11 is trained by using a policy gradient method based on feedback from first model 12 on an output of second model 11. A training sample of first model 12 can be obtained from the batch of samples based on the output of second model 11 to train first model 12.

The above description of system 100 is merely for an illustration purpose. System 100 according to this implementation of the present specification is not limited thereto. For example, the second model and the first model do not need to be trained by using a batch of samples, and alternatively can be trained by using a single sample; and first model 12 is not limited to the anti-fraud model.

FIG. 2 illustrates a method for obtaining a training sample of a first model based on a second model according to some implementations of the present specification. The method includes the following steps:

Step S202: Obtain at least one first sample, each first sample including feature data and a label value, the label value corresponding to a predicted value of the first model. For example, the label value is a prediction value of the first model using the feature data as an input to the first model.

Step S204: Separately input feature data of the at least one first sample into the second model so that the second model separately outputs multiple first output values each based on feature data of a first sample of the at least one first sample, and obtain a first training sample set from the at least one first sample based on the first output values separately output by the second model, a first output value being used to determine whether a corresponding first sample is selected as a training sample of the first training sample set, where the first training set is for training the first model.

First, in step S202, the at least one first sample is obtained, each first sample including feature data and a label value, the label value corresponding to a predicted value of the first model. As described above, the first model is, for example, an anti-fraud model; and the first model is a supervised learning model, is trained by using a labelled sample, and is used to predict whether an input transaction is a fraudulent transaction based on feature data of the transaction. The at least one first sample is a candidate sample that is to be used to train the first model, and the feature data included in the at least one first sample is, for example, a feature data of a transaction, such as a transaction time, a transaction amount, a transaction item name, and a logistics-related feature. The feature data is represented, for example, in the form of a feature vector. The label value is, for example, a label indicating whether a transaction corresponding to a corresponding first sample is a fraudulent transaction. For example, the label value can be 0 or 1; and it indicates that the transaction is a fraudulent transaction when the label value is 1, or it indicates that the transaction is not a fraudulent transaction when the label value is 0.

In step S204, the feature data of the at least one first sample is separately input into the second model so that the second model separately outputs the multiple first output values each based on feature data of a first sample of the at least one first sample, and the first training sample set is obtained from the at least one first sample based on the first output values separately output by the second model, a first output value being used to determine whether a corresponding first sample is selected as a training sample of the first training sample set. The first training set is for training the first model.

The second model is a deep reinforcement learning model, and a training process of the second model is described in detail herein. The second model includes a neural network, and determines whether to select a transaction corresponding to a sample as a training sample of the first model based on feature data of the transaction. That is, an output value of the second model is, for example, 0 or 1. For example, it indicates that the sample is selected as a training sample when the output value is 1, or it indicates that the sample is not selected as a training sample when the output value is 0. Therefore, the corresponding output value (0 or 1) can be separately output from the second model after the feature data of each of the at least one first sample is separately input into the second model. A first sample set selected by using the second model can be obtained as a training sample set, e.g., the first training sample set, of the first model based on the output value separately corresponding to the at least one first sample. If the second model is already a model that has been trained for multiple times, a predicted loss of the first model based on multiple determined test samples by training the first model using the first training sample set is smaller than by training the first model using a training sample set randomly obtained from the at least one first sample, or a training sample set obtained by manually adjusting a use ratio of positive samples to negative samples, etc.

In some embodiments, as described with reference to FIG. 1, in this implementation of the present specification, the second model and the first model are basically trained alternately, instead of training the first model after training the second model. Therefore, in an initial training stage, a predicted loss of the first model that is obtained by training the first model based on the output of the second model is possibly not better, but the predicted loss of the first model gradually decreases as the number of model training times increases. The predicted losses in the present specification are all described with respect to the same multiple determined prediction samples. Like the first sample, the prediction sample includes feature data and a label value, the feature data included in the prediction sample is, for example, feature data of a transaction, and the label value is used to indicate, for example, whether the transaction is a fraudulent transaction. The predicted loss, e.g., under the first model, is, for example, a sum of squares or a sum of absolute values of differences between predicted values of the prediction samples and corresponding label values, an average of the squares of the differences between predicted values of the prediction samples and corresponding label values, or an average of the absolute values of the differences between predicted values of the prediction samples and corresponding label values under the first model.

In some implementations, multiple first samples are separately input into the second model to determine whether each first sample is a training sample of the first model. Therefore, the first training sample set may include multiple selected first samples, so that the first model is trained by using the multiple selected first samples. In some implementations, a single first sample is input into the second model to determine whether to select the first sample as a training sample of the first model. The first model is trained by using the first sample when the second model outputs “yes”; or the first model is not trained, that is, the first training sample set includes zero training samples, when the second model outputs “no”.

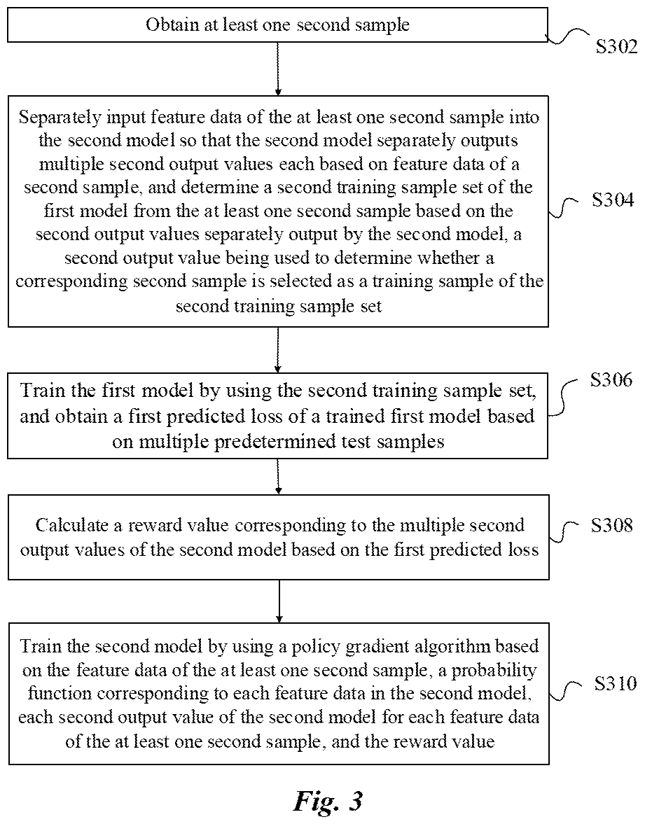

FIG. 3 is a flowchart illustrating a method for training the second model according to some implementations of the present specification. The method includes the following steps:

Step S302: Obtain at least one second sample, each second sample including feature data and a label value, the label value corresponding to a predicted value of the first model.

Step S304: Separately input feature data of the at least one second sample into the second model so that the second model separately outputs multiple second output values each based on feature data of a second sample, and determine a second training sample set of the first model from the at least one second sample based on the second output values separately output by the second model, a second output value being used to determine whether a corresponding second sample is selected as a training sample of the second training sample set.

Step S306: Train the first model by using the second training sample set, and obtain a first predicted loss of a trained first model based on multiple determined test samples, predetermined or dynamically determined.

Step S308: Calculate a reward value corresponding to the multiple second output values of the second model based on the first predicted loss.

Step S310: Train the second model by using a policy gradient algorithm based on the feature data of the at least one second sample, a probability function corresponding to each feature data in the second model, each second output value of the second model for each feature data of the at least one second sample, and the reward value.

As described herein, the second model is a deep reinforcement learning model, the second model includes a probability function corresponding to feature data of an input sample, calculates a probability of selecting the input sample as a training sample of the first model based on the probability function, and outputs a corresponding output value based on the probability, the second model being trained by using the policy gradient method. In the training method, the second model is equivalent to an agent (agent) in reinforcement learning, the first model is equivalent to an environment (Environment) in reinforcement learning, an input of the second model is a state (sᵢ) in reinforcement learning, and an output of the second model is an action (aᵢ) in reinforcement learning. The output of the second model (e.g., the second training sample set) affects the environment. Therefore, the environment generates feedback (e.g., the reward value r), so that the first model is trained based on the reward value r to generate a new action (a new training sample set), to make the environment have better feedback, that is, make a predicted loss of the second model smaller.

Step S302 and step S304 are basically same as step S202 and step S204 in FIG. 2. A difference is as follows: Herein, the at least one second sample is used to train the second model and the at least one first sample is used to train the first model. It can be understood that the at least one first sample can be same as the at least one second sample, that is, after the second model is trained by using the at least one second sample, the at least one second sample is input into a trained second model, so that a training sample of the first model is selected from the at least one second sample to train the first model. Another difference is as follows: The first training sample set is used to train the first model, that is, a model parameter of the first model is changed after the training. The second training sample set is used to train the second model by using a result of training the first model. In some implementations, after the first model is trained by using the second training sample set, the first model can be restored to include model parameters that exist before the training, that is, the training can change or not change the model parameter of the first model.

In step S306, the first model is trained by using the second training sample set, and the first predicted loss of the trained first model is obtained based on the multiple determined test samples.

For obtaining of the first predicted loss, references can be made to the above related descriptions of step S204. Details are omitted herein for simplicity. Herein, similar to the first training sample set, the second training sample set possibly includes zero second samples or one second sample when the at least one second sample is a single second sample. When the second training sample set includes zero samples, the first model is not trained by using a sample, and therefore the second model is not trained, either. When the second training sample set includes one sample, the first model can be trained by using the sample and the first predicted loss can be correspondingly obtained.

In some implementations, after the first predicted loss of the trained first model based on the multiple determined test samples is obtained, the first model can be restored to include model parameters that exist before the training.

In step S308, the reward value corresponding to the multiple second output values of the second model is calculated based on the first predicted loss.

As described herein, the second model is a deep reinforcement learning model, and the second model is trained by using the policy gradient algorithm. For example, the at least one second sample includes n samples s₁, s₂, . . . , and sₙ, n being greater than or equal to 1. The n samples are input into the second model to form an episode (episode). The second training sample set is obtained after the second model completes the episode, and a reward value is obtained after the first model is trained by using the first training sample set. That is, the reward value is obtained based on all the n samples in the episode; in other words, the reward value is a long-term reward of each sample in the episode.

In some implementations, the second model is trained only once based on the at least one second sample. In this case, the reward value is equal to a difference obtained by subtracting the first predicted loss from an initial predicted loss, that is, the reward value r=l₀−l₁. The initial predicted loss is obtained by using the following steps: after the obtaining the at least one second sample, randomly obtaining an initial training sample set from the at least one second sample; and training the first model by using the initial training sample set, and obtaining the initial predicted loss of a trained first model based on the multiple determined test samples. Likewise, after the initial predicted loss of the trained first model based on the multiple determined test samples is obtained, the first model can be restored to include model parameters that exist before the training.

In some implementations, the second model is trained multiple times based on the at least one second sample. The first model is trained by using the method shown in FIG. 2 after each time the second model is trained by using the method shown in FIG. 3 (including the step of restoring the first model). This is iterated for multiple times. In this case, the reward value can be equal to a difference obtained by subtracting the first predicted loss from an initial predicted loss, that is, the reward value r=l₀−l₁. The initial predicted loss is obtained by using the steps described above. Alternatively, in this case, the reward value can be a difference obtained by subtracting the first predicted loss in a current policy gradient method from a first predicted loss in a previous policy gradient method (the method shown in FIG. 3), that is, rᵢ=lᵢ₋₁lᵢ, i being the number of cycles and being greater than or equal to 2. It can be understood that, in this case, a reward value in the first method in the cycle can be equal to a difference obtained by subtracting the first predicted loss from the initial predicted loss, that is, r₁=l₀−l₁, l₀ being obtained as described above.

In some implementations, training of the second model is iterated for multiple times based on the at least one second sample. The first model is trained by using the method shown in FIG. 2 after the second model is trained multiple times by using the policy gradient method shown in FIG. 3 (including the step of restoring the first model in each time of training). That is, the first model remains unchanged in a process of training the second model multiple times based on the at least one second sample. In this case, the reward value is equal to a difference obtained by subtracting the first predicted loss in the current policy gradient method from a first predicted loss in a previous policy gradient method in the cycle, that is, rᵢ=lᵢ₋₁−lᵢ, i being the number of cycles and being greater than or equal to 2. It can be understood that, in this case, a reward value in the first method in the cycle is also equal to a difference obtained by subtracting the first predicted loss from the initial predicted loss, that is, r₁=l₀−l₁, l₀ being obtained as described above.

In some implementations, training of the second model is iterated for multiple times based on the at least one second sample. The step of restoring the first model is not included in each time of training, that is, the first model is also trained in a process of training the second model multiple times based on the at least one second sample. In this case, the reward value can be equal to a difference obtained by subtracting the first predicted loss in the current policy gradient method from a first predicted loss in a previous policy gradient method in the cycle, that is, rᵢ=lᵢ₋₁−lᵢ, i being the number of cycles and being greater than or equal to 2. It can be understood that, in this case, a reward value in the first method in the cycle is also equal to a difference obtained by subtracting the first predicted loss from the initial predicted loss, that is, r₁=l₀−l₁, l₀ being obtained as described above.

It can be understood that a calculation method of the reward value is not limited to the method described herein, and can be specifically designed based on a specific scenario, or a determined calculation precision, etc.

In step S310, the second model is trained by using the policy gradient algorithm based on the feature data of the at least one second sample, the probability function corresponding to each feature data in the second model, each second output value of the second model for each feature data of the at least one second sample, and the reward value.

A policy function of the second model can be shown in equation (1):

π_{θ}(sᵢ, aᵢ)=P_{θ}(aᵢ|sᵢ)=aᵢσ(W*F(sᵢ)+b)+(1−aᵢ)(1−σ(W*F(sᵢ)+b)) (1)

where aᵢ is 1 or 0, θ is a parameter included in the second model, and σ(·) is a sigmoid function and has a parameter {W,b}. F(sᵢ) is a hidden layer feature vector obtained by a neural network of the second model based on a feature vector sᵢ, and an output layer of the neural network performs calculation based on the sigmoid function, to obtain σ(W*F(sᵢ)+b), e.g., a probability of aᵢ=1. For example, a value of aᵢ is 1 when the probability is greater than 0.5, or a value of aᵢ is 0 when the probability is less than or equal to 0.5. As shown in equation (1), a policy function represented by the following equation (2) can be obtained when the value of aᵢ is 1:

π_{θ}(sᵢ, aᵢ=1)=P_{θ}(aᵢ=1|sᵢ)=σ(W*F(sᵢ)+b) (2)

A policy function represented by the following equation (3) can be obtained when the value of aᵢ is 0:

π_{θ}(sᵢ, aᵢ=0)=P_{θ}(aᵢ=0|sᵢ)=1−σ(W*F(sᵢ)+b) (3)

Based on the policy gradient algorithm, for input states s₁, s₂, . . . , and sₙ of an episode, a loss function of the second model is obtained by using corresponding actions a₁, a₂, . . . , and aₙ output by the second model and a value function v corresponding to the episode, as shown in equation (4):

L=−v Σᵢ log π_{θ}(sᵢ, aᵢ) (4)

As described herein, v is the reward value obtained by using the first model as described herein. Therefore, the parameter θ of the second model can be updated by using, for example, a gradient descent method, as shown in equation (5):

θ←θ+α*v Σᵢ∇_{θ} log π_{θ}(sᵢ, aᵢ) (5)

where α is a step of one parameter update in the gradient descent method.

With reference to equation (1) to equation (4), when v>0, a positive reward is obtained for each selection of the second model in the episode. For a sample with aᵢ=1, for example, a sample selected as a training sample of the first model, a policy function is shown in equation (3), and larger π_{θ}(sᵢ, aᵢ=1) indicates a smaller loss function L. For a sample with aᵢ=0, for example, a sample not selected as a training sample of the first model, a policy function is shown in equation (4), and smaller π_{θ}(sᵢ, aᵢ=0) indicates a smaller loss function L. Therefore, after the parameter θ of the second model is adjusted by using the gradient descent method as shown in equation (5), π_{θ}(sᵢ, aᵢ=1) of the sample with aᵢ=1 is larger, and π₀(sᵢ, aᵢ=0) of the sample with aᵢ=0 is smaller. That is, based on the reward value fed back by the first model, the second model is trained when the reward value is a positive value, so that a probability of selecting a selected sample is larger, and a probability of selecting an unselected sample is smaller, thereby reinforcing the second model. When v<0, similarly, the second model is trained, so that a probability of selecting a selected sample is smaller, and a probability of selecting an unselected sample is larger, thereby reinforcing the second model.

As described herein, in some implementations, the second model is trained only once based on the at least one second sample, and r=l₀−l₁. For obtaining of l₀, references can be made to the above description of step S308. That is, in the episode of the second model, v=r=l₀−l₁. In this case, if l₁<l₀, that is, v>0, a predicted loss of a first model trained by using the second training sample set is less than a predicted loss of a first model trained by using a randomly obtained training sample set. Therefore, the parameter of the second model is adjusted, so that a probability of selecting a selected sample in the episode is larger, and a probability of selecting an unselected sample in the episode is smaller. Similarly, if l₁>l₀, that is, v<0, the parameter of the second model is adjusted, so that a probability of selecting a selected sample in the episode is smaller, and a probability of selecting an unselected sample in the episode is larger.

In some implementations, training of the second model is iterated for multiple times based on the at least one second sample. The first model is trained by using the at least one second sample by using the method shown in FIG. 2 after the second model is trained multiple times by using the policy gradient method shown in FIG. 3. In this case, each cycle j corresponds to one episode of the second model, and a reward value of each cycle is rⱼ=lⱼ₋₁−lⱼ. Similar to the above, based on positive/negative of v=rⱼ=lⱼ₋₁−lⱼ in training of each cycle, the parameter of the second model is adjusted in this cycle to reinforce the second model.

Selection of a training sample of the first model can be optimized by performing reinforcement training on the second model, so that the predicted loss of the first model is smaller.

In some implementations, in a process of training the first model and the second model as shown in FIG. 1, the second model possibly converges first. In this case, after a batch of training samples is obtained, the method shown in FIG. 2 can be directly performed to train the first model without training the second model. That is, in this case, the batch of samples is the at least one first sample in the method shown in FIG. 2.

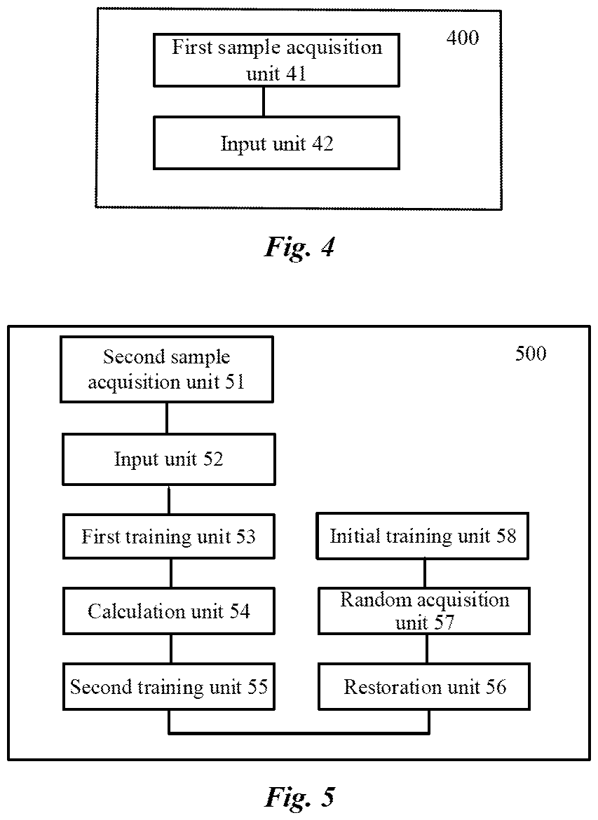

FIG. 4 illustrates apparatus 400 for obtaining a training sample of a first model based on a second model according to some implementations of the present specification. Apparatus 400 includes: first sample acquisition unit 41, configured to obtain at least one first sample, each first sample including feature data and a label value, the label value corresponding to a predicted value of the first model; and input unit 42, configured to separately input feature data of the at least one first sample into the second model so that the second model separately outputs multiple first output values each based on feature data of a first sample of the at least one first sample, and obtain a first training sample set from the at least one first sample based on the first output values separately output by the second model, a first output value being used to determine whether a corresponding first sample is selected as a training sample of the first training sample set, where the first training set is for training the first model.

FIG. 5 illustrates training apparatus 500 configured to train the second model according to some implementations of the present specification. Apparatus 500 includes: second sample acquisition unit 51, configured to obtain at least one second sample, each second sample including feature data and a label value, the label value corresponding to a predicted value of the first model; input unit 52, configured to separately input feature data of the at least one second sample into the second model so that the second model separately outputs multiple second output values each based on feature data of a second sample, and determine a second training sample set of the first model from the at least one second sample based on the second output values separately output by the second model, a second output value being used to determine whether a corresponding second sample is selected as a training sample of the second training sample set; first training unit 53, configured to train the first model by using the second training sample set, and obtain a first predicted loss of a trained first model based on multiple determined test samples, predetermined or dynamically determined; calculation unit 54, configured to calculate a reward value corresponding to the multiple second output values of the second model based on the first predicted loss; and second training unit 55, configured to train the second model by using a policy gradient algorithm based on the feature data of the at least one second sample, a probability function corresponding to each feature data in the second model, each second output value of the second model for each feature data of the at least one second sample, and the reward value.

In some implementations, apparatus 500 further includes restoration unit 56, configured to: after the first predicted loss of the trained first model based on the multiple determined test samples is obtained by using the first training unit, restore the first model to include model parameters that exist before the training.

In some implementations, the reward value is equal to a difference obtained by subtracting the first predicted loss from an initial predicted loss, and apparatus 500 further includes: random acquisition unit 57, configured to: after the at least one second sample is obtained, randomly obtain an initial training sample set from the at least one second sample; and initial training unit 58, configured to train the first model by using the initial training sample set, and obtain the initial predicted loss of a trained first model based on the multiple determined test samples.

In some implementations, implementation of the training apparatus is iterated for multiple times, and the reward value is equal to a difference obtained by subtracting the first predicted loss in the currently implemented training apparatus from a first predicted loss in a previously implemented training apparatus of the currently implemented training apparatus.

Another aspect of the present specification provides a computing device, including a memory and a processor, the memory storing executable code, and the processor implementing any one of the above methods when executing the executable code.

The largest difference between the anti-fraud model and a conventional machine learning model is that a ratio of positive examples to negative examples is very small. To alleviate this problem, the most common solution is up-sampling positive samples or down-sampling negative samples. A ratio needs to be set manually for up-sampling positive examples or down-sampling negative examples, and an improper ratio greatly affects the model. The up-sampling positive examples or the down-sampling negative examples is manually changing data distribution, and therefore a trained model has a deviation. According to the solution of selecting a training sample of the anti-fraud model based on reinforcement learning according to the implementations of the present specification, a sample can be automatically selected through deep reinforcement learning, to train the anti-fraud model, thereby improving a predicted loss of the anti-fraud model.

The implementations of the present specification are all described in a progressive way, for same or similar parts in the implementations, references can be made to each other, and each implementation focuses on a difference from other implementations. Especially, the system implementation is basically similar to the method implementation, and therefore is described briefly. For related parts, references can be made to parts of the method implementation descriptions.

The example implementations of the present specification are described herein. Other implementations fall within the scope of the appended claims. In some cases, the actions or steps described in the claims can be performed in an order different from the order in the implementations and can still achieve the desired results. In addition, the process depicted in the accompanying drawings does not necessarily require the shown particular order or sequence to achieve the desired results. In some implementations, multi-task processing and parallel processing can or may be advantageous.

A person of ordinary skill in the art can be further aware that, in combination with the examples described in the implementations disclosed in the present specification, units and algorithm steps can be implemented by electronic hardware, computer software, or a combination thereof. To clearly describe interchangeability between the hardware and the software, compositions and steps of the example have generally been described in the above specifications based on functions. Whether the functions are performed by hardware or software depends on particular applications and design constraint conditions of the technical solutions. A person of ordinary skill in the art can use different methods to implement the described functions for each particular application, but it should not be considered that the implementation goes beyond the scope of the present application.

Steps of methods or algorithms described in the implementations disclosed in the present specification can be implemented by hardware, a software module executed by a processor, or a combination thereof. The software module can reside in a random access memory (RAM), a memory, a read-only memory (ROM), an electrically programmable ROM, an electrically erasable programmable ROM, a register, a hard disk, a removable disk, a CD-ROM, or any other form of storage medium well-known in the art.

In the above example implementations, the objective, technical solutions, and beneficial effects of the present disclosure are further described in detail. It should be understood that the above descriptions are merely example implementations of the present disclosure, but are not intended to limit the protection scope of the present disclosure. Any modification, equivalent replacement, improvement, etc., made without departing from the spirit and principle of the present disclosure should fall within the protection scope of the present disclosure.

The various embodiments described above can be combined to provide further embodiments. All of the U.S. patents, U.S. patent application publications, U.S. patent applications, foreign patents, foreign patent applications and non-patent publications referred to in this specification and/or listed in the Application Data Sheet are incorporated herein by reference, in their entirety. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A method, comprising:
obtaining at least one first sample, each first sample including feature data and a label value, the label value corresponding to a predicted value of a first model based on the feature data;
obtaining at least one first output value of a second model by separately inputting feature data of each first sample of the at least one first sample into the second model, each first output value being obtained based on feature data of a first sample of the at least one first sample;
obtaining a first training sample set from the at least one first sample based on the at least one first output; and
training the first model using the first training sample set.

2. The method according to claim 1, wherein the second model includes a probability function corresponding to feature data of an input sample, calculates a probability of selecting the input sample as a training sample of the first model based on the probability function, and outputs a corresponding output value based on the probability, and
the method comprises training the second model through acts including:
obtaining at least one second sample, each second sample including feature data and a label value, the label value corresponding to a predicted value of the first model;
separately inputting feature data of the at least one second sample into the second model so that the second model separately outputs at least one second output value each based on feature data of a second sample, and determining a second training sample set of the first model from the at least one second sample based on the at least one second output value;
training the first model by using the second training sample set, and obtaining a first predicted loss of a trained first model based on multiple determined test samples;
calculating a reward value corresponding to the multiple second output values of the second model based on the first predicted loss; and
training the second model by using a policy gradient algorithm based on the feature data of the at least one second sample, a probability function corresponding to each feature data in the second model, each second output value of the second model for each feature data of the at least one second sample, and the reward value.

3. The method according to claim 2, wherein the acts further include after the obtaining the first predicted loss of the trained first model, restoring the first model to include model parameters that exist before the training the first model.

4. The method according to claim 2, wherein the reward value is equal to a difference obtained by subtracting the first predicted loss from an initial predicted loss, and the method further comprises:
after the obtaining the at least one second sample, randomly obtaining an initial training sample set from the at least one second sample; and
training the first model by using the initial training sample set, and obtaining the initial predicted loss of a trained first model based on the multiple determined test samples.

5. The method according to claim 2, wherein the acts are iterated in multiple iterations of trainings, and the reward value is equal to a difference obtained by subtracting a first predicted loss obtained in a current training from a first predicted loss obtained in a previous training immediately before the current training.

6. The method according to claim 2, wherein the at least one first sample is same as the at least one second sample.

7. The method according to claim 1, wherein the first model is an anti-fraud model, the feature data is feature data of a transaction, and the label value indicates whether the transaction is a fraudulent transaction.

8. An apparatus, comprising:
a first sample acquisition unit, configured to obtain at least one first sample, each first sample including feature data and a label value, the label value corresponding to a predicted value of a first model based on the feature data; and
an input unit, configured to obtain at least one first output value of a second model by separately inputting feature data of each first sample of the at least one first sample into the second model, each first output value being obtained based on feature data of a first sample of the at least one first sample, and obtain a first training sample set from the at least one first sample based on the at least one first output value, wherein the first training set is configured to train the first model.

9. The apparatus according to claim 8, wherein the second model includes a probability function corresponding to feature data of an input sample, calculates a probability of selecting the sample as a training sample of the first model based on the probability function, and outputs a corresponding output value based on the probability, the second model being trained by a training apparatus, the training apparatus including:
a second sample acquisition unit, configured to obtain at least one second sample, each second sample including feature data and a label value, the label value corresponding to a predicted value of the first model;
an input unit, configured to separately input feature data of the at least one second sample into the second model so that the second model separately outputs at least one second output values each based on feature data of a second sample, and determine a second training sample set of the first model from the at least one second sample based on the at least one second output values;
a first training unit, configured to train the first model by using the second training sample set, and obtain a first predicted loss of a trained first model based on multiple determined test samples;
a calculation unit, configured to calculate a reward value corresponding to the multiple second output values of the second model based on the first predicted loss; and
a second training unit, configured to train the second model by using a policy gradient algorithm based on the feature data of the at least one second sample, a probability function corresponding to each feature data in the second model, each second output value of the second model for each feature data of the at least one second sample, and the reward value.

10. The apparatus according to claim 9, further comprising a restoration unit, configured to after the first predicted loss of the trained first model, restore the first model to include model parameters that exist before the training the first model.

11. The apparatus according to claim 9, wherein the reward value is equal to a difference obtained by subtracting the first predicted loss from an initial predicted loss, and the apparatus further comprises:
a random acquisition unit, configured to after the at least one second sample is obtained, randomly obtain an initial training sample set from the at least one second sample; and
an initial training unit, configured to train the first model by using the initial training sample set, and obtain the initial predicted loss of a trained first model based on the multiple determined test samples.

12. The apparatus according to claim 9, wherein implementation of the training apparatus is iterated in multiple iterations of trainings, and the reward value is equal to a difference obtained by subtracting a first predicted loss obtained in a currently implemented training apparatus from a first predicted loss obtained in a previously implemented training apparatus immediately before the currently implemented training apparatus.

13. The apparatus according to claim 9, wherein the at least one first sample is same as the at least one second sample.

14. The apparatus according to claim 8, wherein the first model is an anti-fraud model, the feature data is feature data of a transaction, and the label value indicates whether the transaction is a fraudulent transaction.

15. A computing device, comprising a memory and a processor, the memory storing executable code, and when executing the executable code, the processor implements acts including:
obtaining at least one first sample, each first sample including feature data and a label value, the label value corresponding to a predicted value of a first model based on the feature data;
obtaining at least one first output value of a second model by separately inputting feature data of each first sample of the at least one first sample into the second model, each first output value being obtained based on feature data of a first sample of the at least one first sample;
obtaining a first training sample set from the at least one first sample based on the at least one first output; and
training the first model using the first training sample set.

16. The computing device according to claim 15, wherein the second model includes a probability function corresponding to feature data of an input sample, calculates a probability of selecting the input sample as a training sample of the first model based on the probability function, and outputs a corresponding output value based on the probability, and
the acts comprises training the second model through training actions including:
obtaining at least one second sample, each second sample including feature data and a label value, the label value corresponding to a predicted value of the first model;
separately inputting feature data of the at least one second sample into the second model so that the second model separately outputs at least one second output value each based on feature data of a second sample, and determining a second training sample set of the first model from the at least one second sample based on the at least one second output value;
training the first model by using the second training sample set, and obtaining a first predicted loss of a trained first model based on multiple determined test samples;
calculating a reward value corresponding to the multiple second output values of the second model based on the first predicted loss; and
training the second model by using a policy gradient algorithm based on the feature data of the at least one second sample, a probability function corresponding to each feature data in the second model, each second output value of the second model for each feature data of the at least one second sample, and the reward value.

17. The computing device according to claim 16, wherein the training actions further include after the obtaining the first predicted loss of the trained first model, restoring the first model to include model parameters that exist before the training the first model.

18. The computing device according to claim 16, wherein the reward value is equal to a difference obtained by subtracting the first predicted loss from an initial predicted loss, and the training actions further include:
after the obtaining the at least one second sample, randomly obtaining an initial training sample set from the at least one second sample; and
training the first model by using the initial training sample set, and obtaining the initial predicted loss of a trained first model based on the multiple determined test samples.

19. The computing device according to claim 16, wherein the training actions are iterated in multiple iterations of trainings, and the reward value is equal to a difference obtained by subtracting a first predicted loss obtained in a current training from a first predicted loss obtained in a previous training immediately before the current training.

20. The computing device according to claim 15, wherein the first model is an anti-fraud model, the feature data is feature data of a transaction, and the label value indicates whether the transaction is a fraudulent transaction.
